(19) United States
(12) Patent Application Publication
(10) Pub. No.: US 2021/0298007 A1
(43) Pub. Date: Sep. 23, 2021

(54) METHODS, DEVICES AND COMPUTER READABLE MEDIA FOR AUL TRANSMISSION AND RECEPTION

(71) Applicant: NEC CORPORATION, Tokyo (JP)

(72) Inventors: Lin LIANG, Beijing (CN); Gang WANG, Beijing (CN)

(73) Assignee: NEC CORPORATION, Tokyo (JP)

(21) Appl. No.: 17/257,698

(22) PCT Filed: Jul. 6, 2018
(86) PCT No.: PCT/CN2018/094919

§ 371 Date: Jan. 4, 2021

(51) Int. Cl. H04W 72/04; H04L 1/16

(52) U.S. Cl. CPC H04W 72/0413; H04L 1/1607

(57) ABSTRACT

Embodiments of the present disclosure relate to methods, devices and computer readable medium for autonomous uplink (AUL) transmission and reception in a wireless communication system. In an embodiment of the present disclosure, the method for AUL transmission may include transmitting uplink control information (UCI) for an AUL transmission on an uplink control channel; and performing the AUL transmission on an uplink shared channel following the uplink control channel based on the UCI for the AUL transmission.

### FIELD OF THE INVENTION

The non-limiting and exemplary embodiments of the present disclosure generally relate to the field of wireless communication techniques, and more particularly relate to a method, device and computer readable medium for transmitting autonomous uplink (AUL) transmission in a wireless communication system, and a method, device and computer readable medium for AUL reception in a wireless communication system.

### BACKGROUND OF THE INVENTION

This section introduces aspects that may facilitate better understanding of the disclosure. Accordingly, the statements of this section are to be read in this light and are not to be understood as admissions about what is in the prior art or what is not in the prior art.

New radio access system, which is also called as NR system or NR network, is the next generation communication system. In Radio Access Network (RAN) #71 meeting for the third generation Partnership Project (3GPP) working group, study of the NR system was approved. The NR system will consider frequency ranging up to 100 Ghz with an object of a single technical framework addressing all usage scenarios, requirements and deployment scenarios defined in Technical Report TR 38.913, which includes requirements such as enhanced mobile broadband, massive machine-type communications, and ultra-reliable and low latency communications.

In order to improve the data rate performance, in 3GPP Long Term Evolution (LTE), there was introduced License Assisted Access (LAA) for both downlink and uplink transmission. As the LTE network enters its next phase of evolution with the study of wider bandwidth waveform under the NR project, it is natural for the LAA networks to evolve into the 5G NR system. Many features (like Autonomous Uplink (AUL), Clear Channel Access (CCA), Listen Before Talk (LBT) mechanism, etc.) used in LAA in the LTE system may be maintained due to the similarity between the NR unlicensed band and the LTE unlicensed band.

As one of unlicensed channel access solutions, LLA can increase uplink performance (such as throughput, latency, etc.) on unlicensed band by means of CCA and it has been studied as one of objectives in the Work Item (WI) responsible for studying enhancements to LTE operations in unlicensed spectrum. Grant free uplink (GUL) transmission has also been specified in the NR system to reduce Physical Downlink Control Channel (PDCCH) overhead.

In the LTE system, user equipment (UE) specific RRC configuration per LAA secondary Cell (Scell) or per LAA carrier is used to indicate AUL subframe configurations. Particularly, on bitmap with 40 bits per Scell is transmitted to indicate applicable AUL subframes. An activation or release Downlink Control Information (DCI), as LAA Scell specific information, is transmitted on the UL scheduling cell for the LAA SCell to activate or deactivate the AUL transmission. In addition, the evolved node B (eNB) may allow AUL transmission within the eNodeB acquired shared channel occupation time (COT) in subframes belonging to the UL subframes indicated with group common DCI format 1C scrambled by a common Cell Radio Network Temporary Identifier (C-RNTI) (CC-RNTI), only if the COT is acquired using the largest priority class value. A 1-bit field in DCI is used to enable or disable the AUL transmission within an eNB shared COT.

The AUL Uplink Control Information (UCI) contains uplink control information for AUL transmission and it usually contains fields such as Hybrid Automatic Repeat request (HARQ) Identity (ID) (4 bits), New Data Indication (NDI) (1 bit for transmission mode (TM) 1; 2 bits for TM2), reversion (RV) (2 bits), UE ID (16 bits), Physical Uplink Shared Channel (PUSCH) starting point (1 bit: indicating symbol 0 or 1), PUSCH ending point (1 bit: indicating symbol 12 or 13), COT Sharing indication (1 bit: indicating if subframe n+X is an applicable subframe for UL to DL sharing), CRC (16 bits), etc.

For COT sharing indication, a value X is configured by the eNB as part of AUL RRC configuration wherein 1<X<5. If a subframe is indicated as being applicable for UL to DL COT sharing, the UE will stop its AUL PUSCH transmission in the preceding subframe at symbol #12 irrespective of the RRC configuration for the PUSCH ending symbol. IN addition, the AUL PUSCH scrambling sequence uses n_RNTI=[0x0000] for initial transmission.

The AUL downlink feedback indication DFI is used carry feedback information for AUL transmission and it contains bit fields such as Carrier Indication Field (CIF) (0 or 3 bits), AUL DFI flag (1 bit)(set to ‘1’ to differentiate from AUL activation/release), HARQ-ACK bitmap, Transmission Power Control (TPC) for PUSCH (2 bits), Transmission Precoding Matrix Indication (TPMI) (3 or 6 bits, only present for AUL TM2) (in this order).

In the LTE system, Modulation and Coding Scheme (MCS) are the same for all AUL users, which is not a good choice for UE near to the base station. In addition, for the NR on unlicensed band (NR-U), AUL UCI might transmit with ACK UCI and CSI-UCI simultaneously.

### SUMMARY OF THE INVENTION

In general, example embodiments of the present disclosure provide new solutions for AUL transmission and AUL reception in a wireless communication system.

According to a first aspect of the present disclosure, there is provided a method for AUL transmission in a wireless communication system. The method may be performed at a terminal device. The method may include transmitting uplink control information (UCI) for an AUL transmission on an uplink control channel, and transmitting uplink control information (UCI) for an AUL transmission on an uplink control channel.

According to a second aspect of the present disclosure, there is provided a method for AUL reception in a wireless communication system. The method may be performed at network device. The method may include receiving uplink control information (UCI) for an AUL transmission from a terminal device on an uplink control channel; and receiving the AUL transmission from the terminal device on uplink shared channel following the uplink control channel based on the received UCI for the AUL transmission

According to a third aspect of the present disclosure, there is provided a terminal device of data transmission. The terminal device may comprise a processor and a memory. The memory may be coupled with the processor and having program codes therein, which, when executed on the processor, cause the terminal device to perform operations of the first aspect.

According to a fourth aspect of the present disclosure, there is provided a network device. The network device may comprise a processor and a memory. The memory may be coupled with the processor and have program codes therein, which, when executed on the processor, cause the network device to perform operations of the second aspect.

According to a fifth aspect of the present disclosure, there is provided a computer-readable storage medium with computer program codes embodied thereon, the computer program codes configured to, when executed, cause an apparatus to perform actions in the method according to any embodiment in the first aspect.

According to a sixth aspect of the present disclosure, there is provided a computer-readable storage medium with computer program codes embodied thereon, the computer program codes configured to, when executed, cause an apparatus to perform actions in the method according to any embodiment in the second aspect.

According to a seventh aspect of the present disclosure, there is provided a computer program product comprising a computer-readable storage medium according to the fifth aspect.

According to an eighth aspect of the present disclosure, there is provided a computer program product comprising a computer-readable storage medium according to the eighth aspect.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 illustrates an example frame structure in the NR system;

FIG. 2 schematically illustrates a flow chart of a method for AUL transmission in a wireless communication system according to some embodiments of the present disclosure;

FIG. 3 schematically illustrates example UCI transmission for two terminal devices according to an embodiment of the present disclosure;

FIG. 4 schematically illustrates a flow chart of another method for AUL transmission in a wireless communication system according to some embodiments of the present disclosure;

FIG. 5 schematically illustrates a flow chart of a further method for AUL transmission in a wireless communication system according to some embodiments of the present disclosure;

FIGS. 6A to 6C schematically illustrate example mapping of UCI, ACK/NACK and CSI according to some embodiments of the present disclosure;

FIGS. 7A to 7D schematically illustrate example ACK feedback transmission according to some embodiments of the present disclosure;

FIG. 8 schematically illustrates a flow chart of a method for AUL reception in a wireless communication system according to some embodiments of the present disclosure;

FIG. 9 schematically illustrates a flow chart of another method for AUL reception in a wireless communication system according to some embodiments of the present disclosure;

FIG. 10 schematically illustrates a flow chart of a further method for AUL reception in a wireless communication system according to some embodiments of the present disclosure;

FIG. 11 schematically illustrates a block diagram of an apparatus for AUL transmission in a wireless communication system according to some embodiments of the present disclosure;

FIG. 12 schematically illustrates a block diagram of another apparatus for AUL transmission in a wireless communication system according to some embodiments of the present disclosure;

FIG. 13 schematically illustrates a block diagram of an apparatus for AUL reception in a wireless communication system according to some embodiments of the present disclosure;

FIG. 14 is schematically illustrates a block diagram of another apparatus for AUL reception in a wireless communication system according to some embodiments of the present disclosure; and

FIG. 15 schematically illustrates a simplified block diagram of an apparatus 1510 that may be embodied as or comprised in a terminal device like UE, and an apparatus 1520 that may be embodied as or comprised in a network device like gNB as described herein.

### DETAILED DESCRIPTION OF EMBODIMENTS

Hereinafter, the solutions as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner. For example, features illustrated or described as part of one embodiment may be used with another embodiment to yield still a further embodiment. In the interest of clarity, not all features of an actual implementation are described in this specification.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “wireless communication network” refers to a network following any suitable wireless communication standards, such as New Radio (NR), Long Term Evolution (LTE), LTE-Advanced (LTE-A), Wideband Code Division Multiple Access (WCDMA), High-Speed Packet Access (HSPA), and so on. The “wireless communication network” may also be referred to as a “wireless communication system.” Furthermore, communications between network devices, between a network device and a terminal device, or between terminal devices in the wireless communication network may be performed according to any suitable communication protocol, including, but not limited to, Global System for Mobile Communications (GSM), Universal Mobile Telecommunications System (UMTS), Long Term Evolution (LTE), New Radio (NR), wireless local area network (WLAN) standards, such as the IEEE 802.11 standards, and/or any other appropriate wireless communication standard either currently known or to be developed in the future.

As used herein, the term “network device” refers to a node in a wireless communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communications. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “communication device”, “terminal”, “user equipment” and “UE” may be used interchangeably.

As yet another example, in an Internet of Things (JOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink (DL) transmission refers to a transmission from a network device to UE, and an uplink (UL) transmission refers to a transmission in an opposite direction.

The AUL access, as one of unlicensed channel access solutions, can increase uplink performance (such as throughput, latency, etc.) on unlicensed band by means of CCA and it has been studied as one of objectives in the Work Item (WI) responsible for studying enhancements to LTE operations in unlicensed spectrum.

In 3GPP technical document R1-1802867, there is proposed an AUL transmission in the NR unlicensed. According to the proposal, two types of GUL transmissions can be supported in NR system, i.e., Type I and Type II and detailed:
Type I: RRC-only, only RRC is used to signal MCS and available resources
Type II: RRC/DCI (no override of any RRC), RRC and DCI are together used to signal MCS and available resources
Slot-based and mini-slot-based transmission are supported
HARQ are fully supported with 2 approaches
   Grant-based retransmission of transmission block (TB) after Grant free (GF) 1st Tx;
GF first transmission is performed with up to K=8 retransmission (or repetition), w/ early term from explicit ACK
Implicit HARQ ID from selected resources
Implicit HARQ RV sequence from configuration (including RV cycling and RV0 repetition)
Periodic, with multiple transmission opportunities for repetition in each period.
Transmission opportunities are tied to certain RV order ({0,2,3,1}, {0,3,0,3}, and {0,0,0,0} are supported). Initial transmission of repetition must start with RV0, but its timing is flexible otherwise,

However, NR GUL is not sufficient for grant free uplink transmission in NR unlicensed as it does not consider properties in the unlicensed operation.

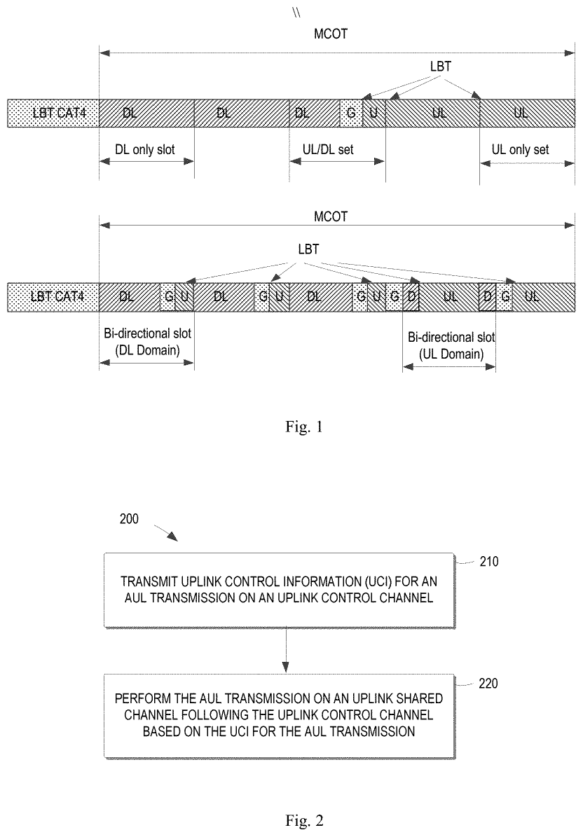

It was agreed in RAN1 #86 that a slot can contain all downlink, all uplink, or at least one downlink part and at least one uplink part. In the 3GPP technical document R1-1801370 it was proposed that the NR-U should strive to fulfil the HARQ feedback/response to UL grant in the same MCOT and gives several examples of NR frame structure on unlicensed bands as illustrated in FIGS. 1A and 1B. In FIG. 1A, in the whole MCOT, there are three parts; the first part is used for DL transmission and the second part is used for the UL transmission and a guard part is located therebetween. In the illustrated frame structure, the LBT could be performed immediately after the guard part or at any start boundary of each UL slot. In FIG. 1B, each slot is a bi-directional slot regardless of UL domain or DL domain and each slot within the MCOT includes a part for DL transmission and a part for UL transmission and a guard part located therebetween. In such a case, one shot LBT (25 us CCA) could be performed at switching point between DL to UL or between UL to DL.

Embodiments of the present disclosure provide new solutions for AUL transmission and reception in a wireless communication. Hereinafter, reference will be further made to accompanying drawings to describe the solutions as proposed in the present disclosure in details. However, it shall be appreciated that the following embodiments are given only for illustrative purposes and the present disclosure is not limited thereto.

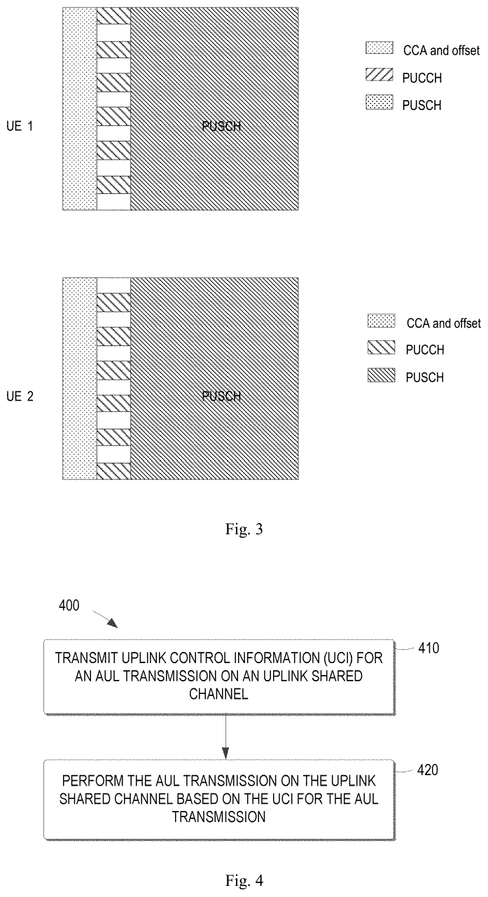

In a first aspect of the present disclosure, there is provided an AUL transmission solution, particularly a UCI transmission solution. In the solution, it is proposed to transmit AUL UCI in the PUCCH. Reference will be first made to FIGS. 2 to 3 to describe the basic idea of the AUL transmission.

FIG. 2 schematically illustrates a flow chart of a method for AUL transmission in a wireless communication system according to some embodiments of the present disclosure. The method 200 can be implemented at a terminal device like UE or any other terminal device.

As illustrated in FIG. 2, in step 210, the terminal device transmits UCI for AUL transmission on an uplink control channel. The UCI contains important control information for AUL transmission and it may include any control information required for the AUL transmission. For example, the UCI for the AUL transmission may contain one or more of the terminal device's identifier, modulation coding scheme, start length indication value for the uplink shared channel, and etc.

In some embodiments of the present disclosure, the terminal device can determine its MCS itself, which can adapt its channel condition (link adaptation) and increase throughput. In some embodiments of the present disclosure, the terminal device can determine its time resources (SLIV) itself, which could provide a flexible rate matching and increase frequency utilization. All these information could be contained in the AUL UCI to information the network device.

In some embodiments of the present disclosure, the PUCCH immediately before the PUSCH for AUL transmission can be used to carry the UCI and in such a case, DMRS in the PUCCH can be used to blind detect the starting symbol of AUL transmission. Therefore, there is no need for another indication for the starting symbol of the AUL transmission and meanwhile the starting symbol of the AUL transmission can be flexible.

In some embodiments of the present disclosure, resources for the UCI for different terminal devices can be orthogonal to each other and the PUSCH for different terminal devices can be overlapped in the full band. For illustrative purposes, FIG. 3 schematically illustrates example UCI transmissions for two terminal devices according to an embodiment of the present disclosure. As illustrated in FIG. 3, both UE1 and UE2 transmit UCI on the PUCCH with resources orthogonal to each other and thus they could share the same PUCCH resource. On the PUSCH, UE1 and UE2 could transmit their respective AUL data and the PUSCH for the two terminal devices could be overlapped in the whole band.

The PUCCH resources for respective terminal devices can be configured by the network device like gNB, through an RRC signaling or any other manner. Thus, in some embodiments of the present disclosure, the terminal device may receive a resource configuration indication for the uplink control channel, wherein the resource configuration indication is used to indicate resource of the uplink control channel, and resource of the uplink control channel being orthogonal to resource of uplink control channel for another terminal device.

In step 220, the terminal device performs the AUL transmission on an uplink shared channel following the uplink control channel based on the UCI for the AUL transmission. In other words, in embodiments of the present disclosure, the UCI is contained in PUCCH and the AUL can be performed in a PUSCH following the PUCCH.

In some embodiments of the present disclosure, the UCI for the AUL transmission is scrambled with a default identifier while uplink data on the uplink shared channel can be scrambled with a Cell Radio Network Temporary Identifier (C-RNTI) of the terminal device. For the PUCCH, it is used to carry the UCI for the AUL transmission, and thus the network device does not have information on the terminal device therebefore. Thus, the terminal device could use a default identifier as a scrambling sequence to scramble the UCI. For example, the default identifier could be a default Cell Radio Network Temporary Identifier (C-RNTI) like n_RNTI=[0x0000]. For the AUL transmission on the PUSCH, it could be scrambled with a C-RNTI of the terminal device since such information is already contained in the PUCCH before the PUSCH. For example, n_RNTI=C-RNTI (UE ID). The PUSCH scrambling could allow Multi-User Multiple-Input Multiple-Output (MU-MIMO) AUL transmission for the same AUL offset. The transmission could be decoded right separately, or at least have benefit for HARQ combination.

In another aspect of the present disclosure, there is also proposed an AUL transmission solution, particularly a UCI transmission solution. In the solution, it is proposed to transmit AUL UCI in the PUSCH, i.e., UCI and uplink data are multiplexed with each other on PUSCH. Reference will be next made to FIGS. 4 to 6C to describe the basic idea of the AUL transmission.

FIG. 4 schematically illustrates a flow chart of another method for AUL transmission in a wireless communication system according to some embodiments of the present disclosure. The method 400 can be implemented at a terminal device like UE or any other terminal device.

As illustrated in FIG. 4, in step 410, the terminal device transmits uplink control information (UCI) for an AUL transmission on an uplink shared channel. The UCI contains important control information for AUL transmission and it may include any information required for the AUL transmission. For example, the UCI for the AUL transmission may contain one or more of the terminal device's identifier, modulation coding scheme (MCS), start length indication value for the uplink shared channel, and etc.

Next in step 420, the terminal device performs the AUL transmission on the uplink shared channel based on the UCI for the AUL transmission. Therefore, the UCI and uplink data are multiplexed with each other on PUSCH.

In such a case, the resources for UCI are calculated based on the PUSCH MCS, and it is not a good choice for UE near the base station such as gNB if the modulation coding schemes for all AUL users are the same. In embodiments of the present disclosure, two types of MCS information can be used, one for the PUSCH resource calculation and the other for PUSCH data modulation. For example, an AUL resource specific parameter MCS_AUL_ref can be configured for resources calculation of PUSCH AUL UCI. At the same time, the MCS for PUSCH data may be UE specific and different from MCS_AUL_ref, and it may be configured respectively by the base station such as gNB through an RRC signaling, or any other manner.

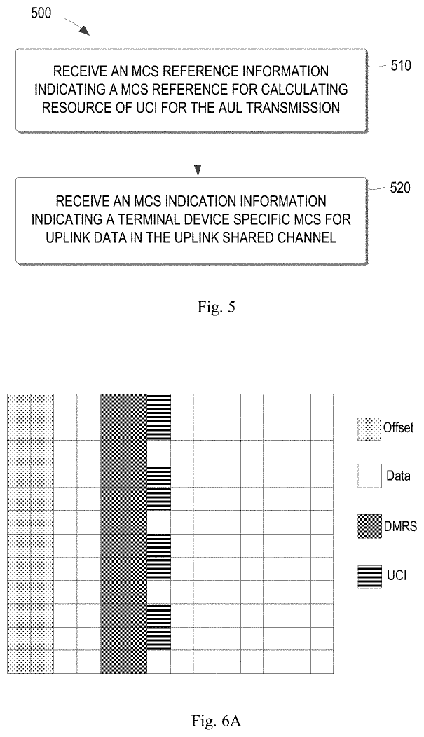

Thus, as illustrated in FIG. 5, in step 510, the terminal device may receive MCS reference information indicating an MCS reference for calculating resource of UCI for the AUL transmission; and in step 520, the terminal device may receive MCS indication information indicating a terminal device specific MCS for uplink data in the uplink shared channel. By means of the two types of MCS information, it is possible to calculate the PUSCH resources based on the MCS reference information and modulate the uplink data using the terminal device specific MCS.

In addition, in LTE AUL transmission, AUL UCI will not be transmitted with ACK UCI and CSI-UCI simultaneously as it can be transmitted in licensed band; while for the standalone NR-U, AUL UCI might be transmitted with ACK UCI and CSI-UCI. In some embodiments of the present disclosure, when AUL UCI, ACK UCI and CSI-UCI are multiplexed, the AUL UCI will be mapped first, and then ACK UCI and CSI-UCI are multiplexed after AUL UCI mapping. In other words, at least one of ACK/NACK UCI and channel state information (CSI) UCI might be transmitted in the uplink control channel and in such a case, the AUL UCI may be mapped before at least one of ACK UCI and CSI UCI, and meanwhile the ACK UCI and the CSI UCI can be only mapped onto resource other than those onto which AUL UCI is mapped.

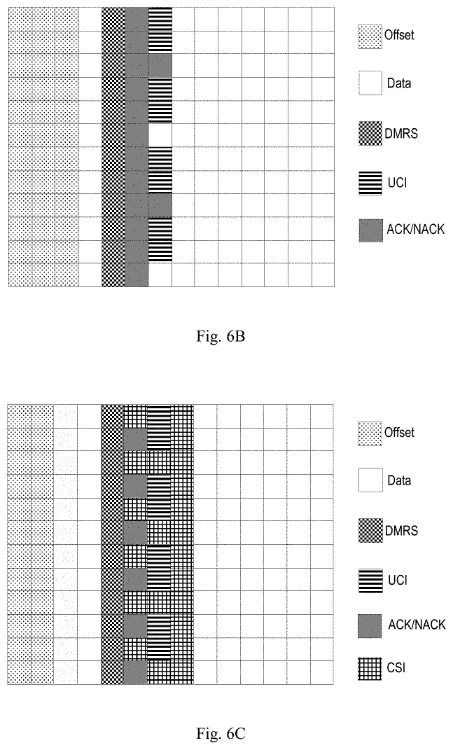

FIGS. 6A to 6C schematically illustrate example mappings of UCI, ACK/NACK and CSI according to some embodiments of the present disclosure. As illustrated in FIGS. 6A to 6C, the horizontal axis denotes a time domain, wherein 14 units represent 14 symbols in a slot; the vertical axis denotes a frequency domain, and 12 units represent 12 subcarriers in a resource block. As illustrated in FIGS. 6A to 6C, the UCI will be mapped first so that its location is unchanged no matter how other control information is mapped. The UCI is always located at the seventh symbol and there are always two resource elements for UCI every three subcarriers. The ACK/NACK UCI and the CSI UCI can be mapped onto those resources which AUL UCI are not mapped to.

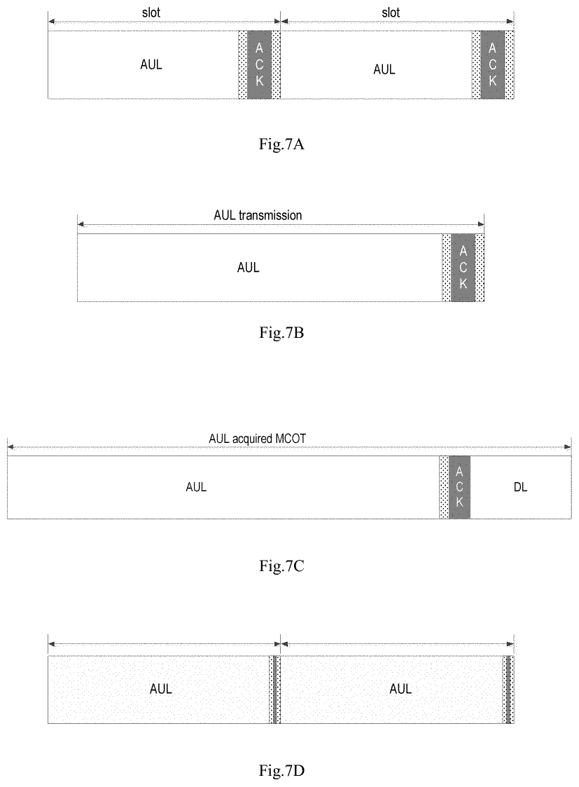

In a further aspect of the present disclosure, there is also proposed an AUL transmission solution, particularly an ACK feedback transmission solution. In the solution, it is proposed to transmit ACK feedback in a new downlink ACK physical channel, which may be called as a self-contained AUL structure to allow for immediate downlink acknowledge for AUL transmission. Reference will be made to FIGS. 7A to 7D to describe the basic idea of the AUL transmission.

FIG. 7A schematically illustrates an example ACK feedback transmission according to some embodiments of the present disclosure. As illustrated in FIG. 7A, an ACK feedback can be configured for each slot. In other words, ACK feedback can be transmitted at each end of the AUL slot and thus the terminal device may receive an ACK feedback for the AUL transmission in each AUL slot.

FIG. 7B schematically illustrates another example ACK feedback transmission according to some embodiments of the present disclosure. As illustrated in FIG. 7B, an ACK feedback can be configured following each AUL transmission. In other words, the terminal device may receive an ACK feedback for the AUL transmission at the end of each AUL transmission.

FIG. 7C schematically illustrates a further example ACK feedback transmission according to some embodiments of the present disclosure. As illustrated in FIG. 7C, an ACK feedback can be configured for every each maximum channel occupation time (MCOT). In other words, an ACK feedback can be transmitted at each end of MCOT and thus the terminal device may receive an ACK feedback for the AUL transmission in each maximum channel occupation time.

FIG. 7D schematically illustrates a still further example ACK feedback transmission according to some embodiments of the present disclosure. As illustrated in FIG. 7D, an ACK feedback can be configured for every slot but the AUL transmission and the ACK feedback receiving can use different subcarrier spacings. It shall be noticed that for the ACK transmission as illustrated in FIGS. 7B and 7C, the ACK feedback could also use a different subcarrier spacing from the AUL transmission.

The channel carrying the ACK feedback can be a specific hybrid automatic repeat request acknowledge information channel (PHICH), which could have a substantially same channel structure and encoding procedure as the PUCCH for downlink transmission ACK; however, the PHICH is downlink channel for ACK of AUL transmission.

Hereinabove, different aspects of the present disclosure are described with reference to operations at the terminal device. In the following, proposed solutions will be further described with reference to operations at the network device.

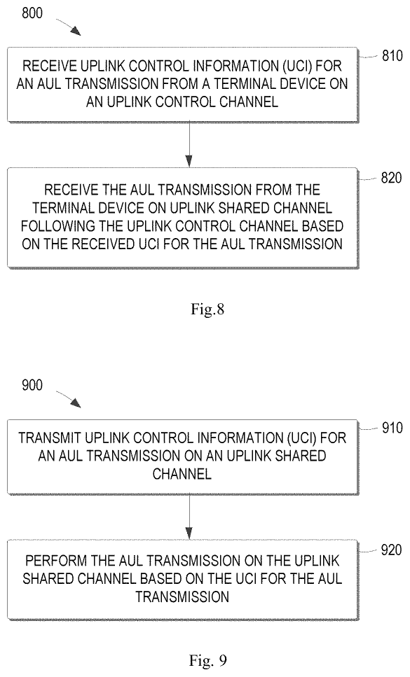

FIG. 8 schematically illustrates a flow chart of a method for AUL reception in a wireless communication system according to some embodiments of the present disclosure. The method 800 can be performed at the network device such as gNB or any other network device.

As illustrated in FIG. 8, in step 810, the network device receives UCI for an AUL transmission from a terminal device on an uplink control channel. The UCI transmitted from the terminal device contains important control information for AUL transmission and it may include any control information required for the AUL transmission. For example, the UCI for the AUL transmission may contain one or more of the terminal device's identifier, modulation coding scheme, start length indication value for the uplink shared channel, and etc.

In some embodiments of the present disclosure, the terminal device can determine its MCS itself, which can adapt its channel condition (link adaptation) and increase throughput. In some embodiments of the present disclosure, the terminal device can determine its time resources (SLIV) itself, which could provide a flexible rate matching and increase frequency utilization. All these information could be contained in the AUL UCI to information the network device.

In some embodiments of the present disclosure, the PUCCH immediately before the PUSCH for AUL transmission can be used to carry the UCI for the AUL transmission and thus the network device could use DMRS in the PUCCH to blind detect the starting symbol of AUL transmission. Therefore, there is no need for another indication for the starting symbol of the AUL transmission and meanwhile the starting symbol of the AUL transmission can be flexible.

In some embodiments of the present disclosure, resources for the UCI for different terminal devices can be orthogonal to each other and the PUSCH for different terminal devices can be overlapped in the full band. Thus, the network device may further transmit a resource configuration indication for the uplink control channel, for example through an RRC signaling, the resource configuration indication indicating resource of the uplink control channel, and resource of the uplink control channel being orthogonal to resource of uplink control channel for another terminal device.

Next in step 820, the network device receives the AUL transmission from the terminal device on uplink shared channel following the uplink control channel based on the received UCI for the AUL transmission.

In some embodiments of the present disclosure, the UCI for the AUL transmission can be scrambled with a default identifier while uplink data on the uplink shared channel is scrambled with a C-RNTI of the terminal device. For example, the default identifier could be a default C-RNTI like n_RNTI=[0x0000]. For the AUL transmission on the PUSCH, it could be scrambled with C-RNTI of the terminal device, for example n_RNTI=C-RNTI (UE ID). Thus, at the network device, the UCI for the AUL transmission can be unscrambled with the default identifier and uplink data on the uplink shared channel can be unscrambled with C-RNTI of the terminal device.

FIG. 9 schematically illustrates a flow chart of a method for AUL reception in a wireless communication system according to some embodiments of the present disclosure, wherein AUL UCI is transmitted in the PUSCH. The method 900 can be implemented at the network device such as gNB or any other network device.

As illustrated in FIG. 9, in step 910, the network device receives uplink control information (UCI) for an AUL transmission on an uplink shared channel. The UCI contains important control information for AUL transmission and it may include any information required for the AUL transmission. For example, the UCI for the AUL transmission may contain one or more of the terminal device's identifier, modulation coding scheme (MCS), start length indication value for the uplink shared channel, and etc.

Next in step 920, the network device receives the AUL transmission on the uplink shared channel based on the UCI for the AUL transmission. In other words, the UCI and uplink data are multiplexed with each other on the PUSCH.

In such a case, the resources for UCI are calculated based on the PUSCH MCS, and it is not a good choice for UE near the base station such as gNB if the modulation coding schemes for all AUL users are the same. In embodiments of the present disclosure, two types of MCS information can be used, one for the PUSCH resource calculation and the other for PUSCH data modulation. Therefore, the network device may configure two types of MCS information for respective terminal devices.

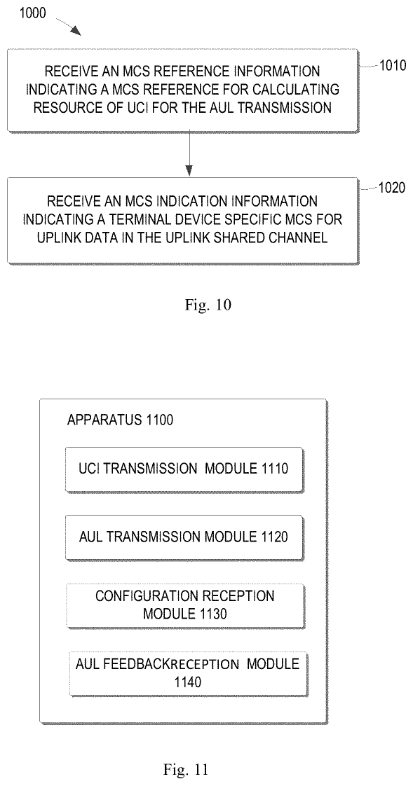

FIG. 10 schematically illustrates a flow chart of a further method for AUL reception in a wireless communication system according to some embodiments of the present disclosure. As illustrated in FIG. 10, in step 1010, the network device may transmit MCS reference information indicating an MCS reference for calculating resource of UCI for the AUL transmission and in step 1020, the network device may transmit MCS indication information indicating a terminal device specific MCS for uplink data in the uplink shared channel. In this way, it is possible for the terminal device to calculate the PUSCH resources based on the MCS reference information and modulate the uplink data using the terminal device specific MCS.

In some embodiments of the present disclosure, when AUL UCI, ACK UCI and CSI-UCI are multiplexed, the AUL UCI will be mapped first, and then ACK UCI and CSI-UCI are multiplexed after AUL UCI mapping. In other words, at least one of ACK/NACK UCI and channel state information (CSI) UCI might be transmitted in the uplink control channel and in such a case, the AUL UCI may be mapped before at least one of ACK UCI and CSI UCI, and meanwhile the ACK UCI and the CSI UCI can be only mapped onto resource other than those onto which AUL UCI is mapped. Thus, at the network device, the AUL UCI can be decoded before at least one of ACK UCI and CSI UCI.

In a further aspect of the present disclosure, there is also proposed an AUL transmission solution, particularly an ACK feedback solution. In some embodiments of the present disclosure, an ACK feedback or the AUL transmission can be transmitted at the end of each AUL transmission. In some embodiments of the present disclosure, the ACK feedback for the AUL transmission can be transmitted in each AUL slot. In some embodiments of the present disclosure, an ACK feedback for the AUL transmission can be transmitted in each maximum channel occupation time. In some embodiments of the present disclosure, the AUL receiving and the ACK feedback transmission can be performed with different subcarrier spacings.

The channel carrying the ACK feedback can be a specific hybrid automatic repeat request acknowledge information channel (PHICH), which could have a substantially same channel structure and encoding procedure as the PUCCH for ACK of downlink transmission; however, the PHICH is downlink channel for AUL transmission ACK. Thus, at the network device, the ACK feedback can be transmitted on the PHICH having a substantially same channel structure to the uplink control channel.

Hereinabove, various aspects of AUL reception solution on the network device are described in brief hereinbefore with reference to FIGS. 8 to 10. However, it can be understood that operations at the network device are corresponding to those at the terminal device and thus for some details of operations, one may refer to description with reference to FIGS. 2 to 7D. In addition, the skilled in the art could be understood the above aspects or various operations therein could be combined in any suitable manner to benefit therefrom.

FIG. 11 schematically illustrates a block diagram of an apparatus for AUL transmission in a wireless communication system according to some embodiments of the present disclosure. The apparatus 1100 can be implemented at a terminal device or any other terminal device.

As illustrated in FIG. 11, the apparatus 1100 may include a UCI transmission module 1110 and an AUL transmission module 1120. The UCI transmission module 1110 may be configured to transmit uplink control information (UCI) for an AUL transmission on an uplink control channel. The AUL transmission module 1120 may be configured to perform the AUL transmission on an uplink shared channel following the uplink control channel based on the UCI for the AUL transmission.

In some embodiments of the present disclosure, the apparatus 1100 may further comprises a configuration reception module 1130. The configuration reception module may be configured to receive a resource configuration indication for the uplink control channel, the resource configuration indication indicating resource of the uplink control channel, and resource of the uplink control channel being orthogonal to resource of uplink control channel for another terminal device.

In some embodiments of the present disclosure, the UCI for the AUL transmission may be scrambled with a default identifier and uplink data on the uplink shared channel may be scrambled with a Cell Radio Network Temporary Identifier (C-RNTI) of the terminal device.

In some embodiments of the present disclosure, the UCI for the AUL transmission may contains one or more of the terminal device's identifier, modulation coding scheme, and start length indication value for the uplink shared channel.

In some embodiments of the present disclosure, the apparatus 1100 may further comprise an AUL feedback receiving module 1140. In some embodiments of the present disclosure, the AUL feedback reception module 1140 may be configured to receive an ACK feedback for the AUL transmission at the end of each AUL transmission. In some embodiments of the present disclosure, the AUL feedback reception module 1140 may be configured to receive an ACK feedback for the AUL transmission in each AUL slot. In some embodiments of the present disclosure, the AUL feedback reception module 1140 may be configured to receive an ACK feedback for the AUL transmission in each maximum channel occupation time.

In some embodiments of the present disclosure, the AUL transmission and the ACK feedback receiving may be performed with different subcarrier spacings.

In some embodiments of the present disclosure, the AUL feedback reception module 1140 may be configured to receive an ACK feedback on a hybrid automatic repeat request acknowledge information channel having a substantially same channel structure to the uplink control channel for ACK.

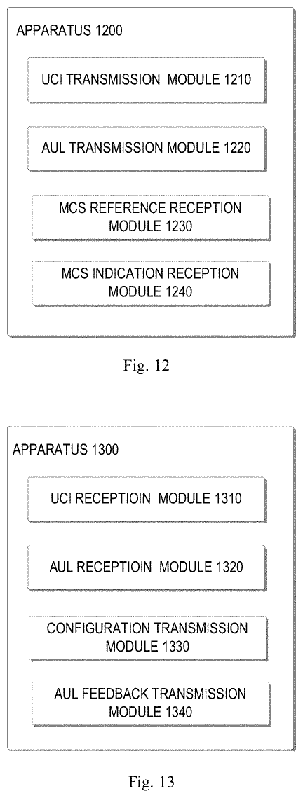

FIG. 12 schematically illustrates a block diagram of an apparatus for AUL transmission in a wireless communication system according to some embodiments of the present disclosure. The apparatus 1200 can be implemented at a terminal device or any other terminal device.

As illustrated in FIG. 12, the apparatus 1200 may include a UCI transmission module 1210, and an AUL transmission module 1220. The UCI transmission module 1210 may be configured to transmit uplink control information (UCI) for an AUL transmission on an uplink shared channel. The AUL transmission module 1220 may be configured to perform the AUL transmission on the uplink shared channel based on the UCI for the AUL transmission.

In some embodiments of the present disclosure, the apparatus 1200 may further comprise an MCS reference reception module 1230 and an MCS indication reception module 1240. The MCS reference reception module 1230 may be configured to receive MCS reference information indicating an MCS reference for calculating resource of UCI for the AUL transmission. The MCS indication reception module 1240 may be configured to receive MCS indication information indicating a terminal device specific MCS for uplink data in the uplink shared channel.

In some embodiments of the present disclosure, at least one of ACK/NACK UCI and channel state information (CSI) UCI may be transmitted in the uplink control channel and the AUL UCI may be mapped before at least one of ACK UCI and CSI UCI and ACK UCI and CSI UCI may be mapped onto only resource other than those onto which AUL UCI is mapped.

FIG. 13 schematically illustrates a block diagram of an apparatus for AUL reception in a wireless communication system according to some embodiments of the present disclosure. The method 1300 can be implemented at the network device such as gNB or any other network device.

As illustrated in FIG. 13, the apparatus 1300 may include a UCI reception module 1310 and an AUL reception module 1320. The UCI reception module 1310 may be configured to receive uplink control information (UCI) for an AUL transmission from a terminal device on an uplink control channel. The AUL reception module 1320 may be configured to receive the AUL transmission from the terminal device on uplink shared channel following the uplink control channel based on the received UCI for the AUL transmission.

In some embodiments of the present disclosure, the apparatus 1300 may further comprise a configuration transmission module 1330. The configuration transmission module 1330 may be configured to transmit a resource configuration indication for the uplink control channel, the resource configuration indication indicating resource of the uplink control channel, and resource of the uplink control channel being orthogonal to resource of uplink control channel for another terminal device.

In some embodiments of the present disclosure, the UCI for the AUL transmission may be unscrambled with a default identifier and uplink data on the uplink shared channel may be unscrambled with Cell Radio Network Temporary Identifier of the terminal device.

In some embodiments of the present disclosure, the UCI for the AUL transmission contains one or more of the terminal device's identifier, modulation coding scheme, and start length indication value for the uplink shared channel

In some embodiment of the present disclosure, the apparatus 1300 may further comprise AUL feedback transmission module 1340. In some embodiments of the present disclosure, the AUL feedback transmission module 1340 may be configured to transmit an ACK feedback for the AUL transmission at the end of each AUL transmission. In some embodiments of the present disclosure, the AUL feedback transmission module 1340 may be configured to transmit an ACK feedback for the AUL transmission in each AUL slot. In some embodiments of the present disclosure, the AUL feedback transmission module 1340 may be configured to transmit an ACK feedback for the AUL transmission in each maximum channel occupation time.

In some embodiments of the present disclosure, the AUL receiving and the ACK feedback transmission can be performed with different subcarrier spacings.

In some embodiments of the present disclosure, The AUL feedback transmission module 1340 may be further configured to transmit an ACK feedback on a hybrid automatic repeat request acknowledge information channel having a substantially same channel structure to the uplink control channel for ACK.

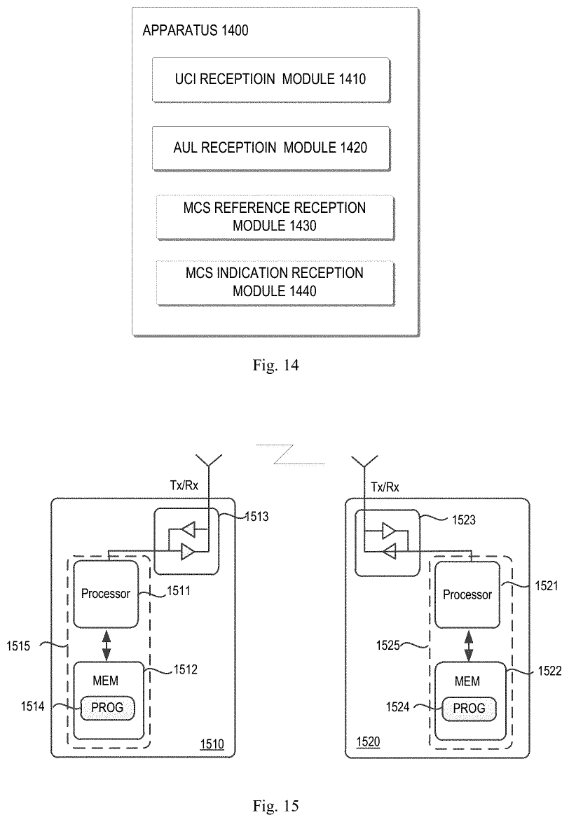

FIG. 14 is schematically illustrates a block diagram of an apparatus for AUL reception in a wireless communication system according to some embodiments of the present disclosure. The apparatus 1400 may be performed at the network device such as gNB or any other network device.

As illustrated in FIG. 14, the apparatus 1400 may include a UCI reception module 1410 and an AUL reception module 1420. The UCI reception module 1410 may be configured to receive uplink control information (UCI) for an AUL transmission on an uplink shared channel. The AUL reception module 1420 may be configured to receive the AUL transmission on the uplink shared channel based on the UCI for the AUL transmission.

In some embodiments of the present disclosure, the apparatus 1400 may further include an MCS reference reception module 1430 and an MCS indication reception module 1440. The MCS reference reception module 1430 may be configured to transmit MCS reference information indicating an MCS reference for calculating resource of UCI for the AUL transmission. The MCS indication reception module 1440 may be configured to transmit MCS indication information indicating a terminal device specific MCS for uplink data in the uplink shared channel.

In some embodiments of the present disclosure, at least one of ACK/NACK UCI and channel state information (CSI) UCI can be received in the uplink control channel and the AUL UCI can decoded before at least one of ACK UCI and CSI UCI.

Hereinabove, apparatuses 1100 to 1400 are described with reference to FIGS. 11 and 14 in brief. It can be noticed that the apparatuses 1100 to 1400 may be configured to implement functionalities as described with reference to FIGS. 2 to 10. Therefore, for details about the operations of modules in these apparatuses, one may refer to those descriptions made with respect to the respective steps of the methods with reference to FIGS. 2 to 10.

It is further noticed that components of the apparatuses 1100 to 1400 may be embodied in hardware, software, firmware, and/or any combination thereof. For example, the components of apparatuses 1100 to 1400 may be respectively implemented by a circuit, a processor or any other appropriate selection device.

Those skilled in the art will appreciate that the aforesaid examples are only for illustration not limitation and the present disclosure is not limited thereto; one can readily conceive many variations, additions, deletions and modifications from the teaching provided herein and all these variations, additions, deletions and modifications fall the protection scope of the present disclosure.

In addition, in some embodiment of the present disclosure, apparatuses 1100 to 1400 may include at least one processor. The at least one processor suitable for use with embodiments of the present disclosure may include, by way of example, both general and special purpose processors already known or developed in the future. Apparatuses 1100 to 1400 may further include at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause apparatuses 1100 to 1400 to at least perform operations according to the method as discussed with reference to FIGS. 2 to 11 respectively.

FIG. 15 schematically illustrates a simplified block diagram of an apparatus 1510 that may be embodied as or comprised in a terminal device like UE, and an apparatus 1520 that may be embodied as or comprised in a network device like gNB as described herein.

The apparatus 1510 comprises at least one processor 1511, such as a data processor (DP) and at least one memory (MEM) 1512 coupled to the processor 1511. The apparatus 1510 may further include a transmitter TX and receiver RX 1513 coupled to the processor 1511, which may be operable to communicatively connect to the apparatus 1520. The MEM 1512 stores a program (PROG) 1514. The PROG 1514 may include instructions that, when executed on the associated processor 1511, enable the apparatus 1510 to operate in accordance with embodiments of the present disclosure, for example any of methods 200, 400 and 500. A combination of the at least one processor 1511 and the at least one MEM 1512 may form processing means 1515 adapted to implement various embodiments of the present disclosure.

The apparatus 1520 comprises at least one processor 1521, such as a DP, and at least one MEM 1522 coupled to the processor 1521. The apparatus 1520 may further include a suitable TX/RX 1523 coupled to the processor 2151, which may be operable for wireless communication with the apparatus 1510. The MEM 1522 stores a PROG 1524. The PROG 1524 may include instructions that, when executed on the associated processor 2151, enable the apparatus 1520 to operate in accordance with the embodiments of the present disclosure, for example to perform any of methods 800 to 1000. A combination of the at least one processor 1521 and the at least one MEM 1522 may form processing means 1525 adapted to implement various embodiments of the present disclosure.

Various embodiments of the present disclosure may be implemented by computer program executable by one or more of the processors 1511, 1521, software, firmware, hardware or in a combination thereof.

The MEMs 1512 and 1522 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 1511 and 1521 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method for autonomous uplink (AUL) transmission, comprising:
at a terminal device,
transmitting uplink control information (UCI) for an AUL transmission on an uplink control channel; and
performing the AUL transmission on an uplink shared channel following the uplink control channel based on the UCI for the AUL transmission.

2. The method of claim 1, further comprising:
receiving a resource configuration indication for the uplink control channel, the resource configuration indication indicating resource of the uplink control channel, and resource of the uplink control channel being orthogonal to resource of uplink control channel for another terminal device.

3. The method of claim 1, wherein the UCI for the AUL transmission is scrambled with a default identifier and wherein uplink data on the uplink shared channel is scrambled with a Cell Radio Network Temporary Identifier (C-RNTI) of the terminal device.

4. The method of claim 1 wherein the UCI for the AUL transmission contains one or more of the terminal device's identifier, modulation coding scheme, and start length indication value for the uplink shared channel.

5. The method of claim 1, further comprising any one of:
receiving an ACK feedback for the AUL transmission at the end of each AUL transmission;
receiving an ACK feedback for the AUL transmission in each AUL slot; or
receiving an ACK feedback for the AUL transmission in each maximum channel occupation time.

6. The method of claim 5, wherein the AUL transmission and the ACK feedback receiving are performed with different subcarrier spacings.

7. The method of claim 1, further comprising:
receiving an ACK feedback on a hybrid automatic repeat request acknowledge information channel having a substantially same channel structure to an uplink control channel for ACK.

8. A method for autonomous uplink (AUL) reception, comprising
at a network device,
receiving uplink control information (UCI) for an AUL transmission from a terminal device on an uplink control channel; and
receiving the AUL transmission from the terminal device on uplink shared channel following the uplink control channel based on the received UCI for the AUL transmission.

9. The method of claim 8, further comprising
transmitting a resource configuration indication for the uplink control channel, the resource configuration indication indicating resource of the uplink control channel, and resource of the uplink control channel being orthogonal to resource of uplink control channel for another terminal device.

10. The method of claim 8, wherein the UCI for the AUL transmission is unscrambled with a default identifier and wherein uplink data on the uplink shared channel is unscrambled with Cell Radio Network Temporary Identifier of the terminal device.

11. The method of claim 8, wherein the UCI for the AUL transmission contains one or more of the terminal device's identifier, modulation coding scheme, and start length indication value for the uplink shared channel.

12. The method of claim 8, further comprising any one of:
transmitting an ACK feedback for the AUL transmission at the end of each AUL transmission;
transmitting an ACK feedback for the AUL transmission in each AUL slot; or
transmitting an ACK feedback for the AUL transmission in each maximum channel occupation time.

13. The method of claim 12, wherein the AUL receiving and the ACK feedback transmission are performed with different subcarrier spacings.

14. The method claim 8, further comprising:
transmitting an ACK feedback on a hybrid automatic repeat request acknowledge information channel having a substantially same channel structure to the uplink control channel for ACK.

15. A terminal device, comprising:
at least one processor; and
at least one memory including computer program codes;
the at least one memory and the computer program codes are configured to, with the at least one processor, cause the terminal device at least to perform the method of claim 1.

16.-18. (canceled)
